(19) United States
(12) Patent Application Publication
(10) Pub. No.: US 2026/0201564 A1
(43) Pub. Date: Jul. 16, 2026

(54) METHODS FOR SILANIZATION OF SUBSTRATES

(71) Applicant: Medtronic, Inc., Minneapolis, MN (US)

(72) Inventors: Marc A. Rufin, Brooklyn Park, MN (US); Kimberly A. Chaffin, Woodbury, MN (US); Jordyn L. McClain, Washington, DC (US); Brian R. Upadhyaya, Woodbury, MN (US)

(21) Appl. No.: 19/137,081

(22) PCT Filed: Nov. 28, 2023
(86) PCT No.: PCT/IB2023/061982

§ 371 Date: Jun. 9, 2025

Related U.S. Application Data
(60) Provisional application No. 63/433,302, filed on Dec. 16, 2022.

(51) Int. Cl. C23C 22/58; C09D 183/06; C23C 22/78

(52) U.S. Cl. CPC C23C 22/58; C09D 183/06; C23C 22/78

(57) ABSTRACT

A method of silanizing a surface of a substrate includes preparing a reagent solution with one or more alkoxysilanes by lowering a pH of the reagent solution to pH 1 to 6.5; subsequently increasing the pH of the reagent solution to pH 4 to 8; activating the surface to introduce reactive groups; contacting the activated surface with the reagent solution; and drying the surface. The alkoxysilanes may include monoalkoxysilanes, dialkoxysilanes, trialkoxysilanes, or a combination thereof. A substrate prepared by the methods of the present disclosure may include a surface; and a silane coating grafted onto the surface, the silane coating including silanes prepared from one or more monoalkoxysilanes, dialkoxysilanes, or a combination thereof, wherein the coating exhibits a silicon elemental concentration of 0.5 atomic % or more.

This application claims the benefit of U.S. Provisional Patent Application Ser. No. 63/433,302, filed Dec. 16, 2022, the entire content of which is incorporated herein by reference.

### FIELD

The present disclosure relates to methods for silanization of substrates. The present disclosure further relates to silanization of articles, such as medical devices.

### SUMMARY

A method of silanizing a surface of a substrate includes preparing a reagent solution with one or more alkoxysilanes by lowering the pH of the reagent solution to pH 1 to 6.5; subsequently increasing the pH of the reagent solution to pH 4 to 8; activating the surface to introduce reactive groups; contacting the activated surface with the reagent solution; and drying the surface. The alkoxysilanes may include monoalkoxysilanes, dialkoxysilanes, trialkoxysilanes, or a combination thereof.

A method of silanizing a surface of a substrate includes activating the surface to introduce reactive groups; contacting the activated surface with a reagent solution comprising monoalkoxysilanes, dialkoxysilanes, trialkoxysilanes, or a combination thereof; and drying the surface.

The reactive groups may be hydroxyl groups. The surface may be activated using an activation solution comprising water and a base. The surface may be activated using plasma, such as oxygen plasma. The substrate may be or include a metal, such as nitinol, titanium, cobalt chromium, or steel.

The reagent solution may include an alcohol and water. The alcohol may be selected from ethanol, methanol, isopropanol, and combinations thereof. The reagent solution may include from 0.5 vol-% to 50 vol-% water, from 1 vol-% to 10 vol-%, or from 2 vol-% to 8 vol-% water, optionally with the balance the selected alcohol. The reagent solution may have a pH from 4.5 to 8, 6 to 8, or about 7 when contacting with the surface. The method may result in a silicon elemental concentration of 0.5 atomic % or greater on the surface.

The reagent solution may include monoalkoxysilanes represented by Formula (I):

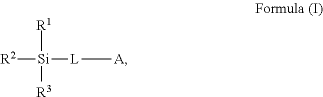

wherein L is a linker, A is a functional group, R1, R2, and R3 are independently alkoxyl or alkyl groups, at least one of R1, R2, and R3 being an alkoxyl group. The reagent solution may include alkoxysilanes, and wherein R1 is methoxyl, ethoxyl, or propoxyl. The functional group A may include an epoxide, a carboxylic acid, a halide, a (meth)acrylate, an alkoxyl, a cyanate, a thiol, or an amine. The linker L may include a carbon-containing group with up to 20 carbon atoms, up to 10 carbon atoms, 1 to 5 carbon atoms, 1 to 4 carbon atoms, 1 to 3 carbon atoms, or 1 or 2 carbon atoms, optionally comprising one or more heteroatoms selected from oxygen, nitrogen, and sulfur, wherein linker L is saturated or unsaturated, and wherein linker L is linear, branched, and optionally includes one or more cyclic groups. The linker L may include an alkyl, alkoxyl, one or more polyethylene glycol repeats, phenyl, or a combination thereof.

In some embodiments, the reagent solution is free or substantially free of trialkoxysilanes.

The method may further include contacting the dried surface grafted with silanes with a grafting molecule. The grafting molecule may include a zwitterionic compound. The zwitterionic compound may include phosphorylcholine.

A substrate prepared by the methods of the present disclosure may include a surface; and a silane coating grafted onto the surface, the silane coating including silanes prepared from one or more monoalkoxysilanes, dialkoxysilanes, trialkoxysilanes, or a combination thereof, wherein the coating exhibits a silicon elemental concentration of 0.5 atomic % or more.

### BRIEF DESCRIPTION OF FIGURES

FIGS. 1A and 1B are schematics showing a surface activated using a basic solution, exposing free hydroxyl groups (A), and the treated surface reacted with a monoalkoxysilane in the presence of ethanol to form a silane coating (B).

FIG. 2 is a schematic of a method consistent with one or more methods described herein.

FIG. 3 is a graphical representation showing the nickel and silicon content correlating to nitinol and silicon content of nitinol surfaces activated and grafted to a silane in Example 1. The clean nitinol sample was not treated or grafted, and serves as a negative control.

FIG. 4 is a graphical representation showing the Ni, Si, N, and P content to demonstrate grafting efficiency in Example 2.

### DEFINITIONS

All scientific and technical terms used herein have meanings commonly used in the art unless otherwise specified. The definitions provided herein are to facilitate understanding of certain terms used frequently herein and are not meant to limit the scope of the present disclosure.

Unless otherwise indicated, the terms “polymer” and “polymeric material” include, but are not limited to, organic homopolymers, copolymers, such as for example, block, graft, random and alternating copolymers, terpolymers, etc., and blends and modifications thereof. Furthermore, unless otherwise specifically limited, the term “polymer” shall include all possible geometrical configurations of the material. These configurations include, but are not limited to, isotactic, syndiotactic, and atactic symmetries.

The term “aromatic ring” is used in this disclosure to refer to a conjugated ring system of an organic compound. Aromatic rings may include carbon atoms only, or may include one or more heteroatoms, such as oxygen, nitrogen, or sulfur.

The term “alkylated” is used in this disclosure to describe compounds that are reacted to replace a hydrogen atom or a negative charge of the compound with an alkyl group, such that the alkyl group is covalently bonded to the compound.

The term “alkyl” is used in this disclosure to describe a monovalent group that is a radical of an alkane and includes straight-chain, branched, cyclic, and bicyclic alkyl groups, and combinations thereof, including both unsubstituted and substituted alkyl groups. Unless otherwise indicated, the alkyl groups typically contain from 1 to 30 carbon atoms. In some embodiments, the alkyl groups contain 1 to 20 carbon atoms, 1 to 10 carbon atoms, 1 to 6 carbon atoms, 1 to 4 carbon atoms, or 1 to 3 carbon atoms. Examples of alkyl groups include, but are not limited to, methyl, ethyl, n-propyl, n-butyl, n-pentyl, isobutyl, t-butyl, isopropyl, n-octyl, n-heptyl, ethylhexyl, cyclopentyl, cyclohexyl, cycloheptyl, etc.

The term “(meth)acrylic” refers to acrylic and methacrylic monomers, and “(meth)acrylate” refers to acrylate and methacrylate monomers.

The term “substantially” as used here has the same meaning as “significantly,” and can be understood to modify the term that follows by at least about 90%, at least about 95%, or at least about 98%. The term “substantially free” of a particular compound means that the compositions of the present invention contain less than 1,000 parts per million (ppm) of the recited compound. In the context of the aforementioned phrases, the compositions of the present invention contain less than the aforementioned amount of the compound whether the compound itself is present in unreacted form or has been reacted with one or more other materials.

The term “not substantially” as used here has the same meaning as “not significantly,” and can be understood to have the inverse meaning of “substantially,” i.e., modifying the term that follows by not more than 25%, not more than 10%, not more than 5%, or not more than 2%.

The term “about” is used here in conjunction with numeric values to include normal variations in measurements as expected by persons skilled in the art, and is understood to have the same meaning as “approximately” and to cover a typical margin of error, such as ±5% of the stated value.

Terms such as “a,” “an,” and “the” are not intended to refer to only a singular entity, but include the general class of which a specific example may be used for illustration.

The terms “a,” “an,” and “the” are used interchangeably with the term “at least one.” The phrases “at least one of” and “comprises at least one of” followed by a list refers to any one of the items in the list and any combination of two or more items in the list.

As used here, the term “or” is generally employed in its usual sense including “and/or” unless the content clearly dictates otherwise. The term “and/or” means one or all of the listed elements or a combination of any two or more of the listed elements.

The recitations of numerical ranges by endpoints include all numbers subsumed within that range (e.g., 1 to 5 includes 1, 1.5, 2, 2.75, 3, 3.80, 4, 5, etc. or 10 or less includes 10, 9.4, 7.6, 5, 4.3, 2.9, 1.62, 0.3, etc.). Where a range of values is “up to” or “at least” a particular value, that value is included within the range.

As used here, “have,” “having,” “include,” “including,” “comprise,” “comprising,” or the like are used in their open-ended sense, and generally mean “including, but not limited to.” It will be understood that “consisting essentially of,” “consisting of,” and the like are subsumed in “comprising” and the like. As used herein, “consisting essentially of,” as it relates to a composition, product, method, or the like, means that the components of the composition, product, method, or the like are limited to the enumerated components and any other components that do not materially affect the basic and novel characteristic(s) of the composition, product, method, or the like.

The words “preferred” and “preferably” refer to embodiments that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the disclosure, including the claims.

Any direction referred to here, such as “top,” “bottom,” “left,” “right,” “upper,” “lower,” and other directions and orientations are described herein for clarity in reference to the figures and are not to be limiting of an actual device or system or use of the device or system. Devices or systems as described herein may be used in a number of directions and orientations.

### DETAILED DESCRIPTION

The present disclosure relates to methods of applying a silane coating onto (e.g., silanizing) the surface of an article. The present disclosure relates to articles having a silane coating. The articles may include medical devices, such as implantable devices.

Various coatings may be applied onto material surfaces to alter the surface properties of the material. In some cases, coatings may be grafted onto the surface of the material so that the coating is chemically (e.g., covalently) bonded onto the surface. Examples of various properties that may be achieved by silanization or applying a subsequent coating to the silane include anti-fouling, low friction, lubrication, adhesion promotion, hydrophobicity, hydrophilicity, non-wetting, etc. To facilitate grafting of the coating onto the surface, the surface may be first silanized to provide a coupling layer for the coating to adhere. The term “silanizing” is used to refer to the application of a silane coating onto a surface. The term “silane coating” refers to a layer, typically the outermost layer, of an article, where the layer is composed at least partially of a silicon and carbon-containing molecule. The silane coating may be a uniform monolayer. As described herein in greater detail, the silane coating may be a monolayer that is not crosslinked.

For example, various surfaces, such as certain medical devices (e.g., implantable devices, surgical tools) may be treated with a fouling resistant coating to reduce biofouling during use. In the context of implantable medical devices, fouling resistant coatings and reduced biofouling may be used to reduce the risk of material-induced thrombosis and infection. Examples of implantable medical devices that may benefit from fouling resistant coatings include stents, dialysis catheters, ventricular assist devices, prosthetic implants, stent grafts, diabetic glucose sensors, and the like. The devices may be made of various materials, including metals and polymers. In some cases, the devices include parts made of nitinol, an alloy of nickel and titanium. Fouling resistant coatings may feature a silane coupling agent to facilitate coating adhesion to the article. The silane coating may be applied onto the material of the device, such as onto the nitinol or another substrate.

Additionally, certain medical or other devices may benefit from a coating in other ways. For example, coatings may beneficially alter the lubriciousness of a material, decrease friction, promote adhesion or formation of a capsule in a body, or be non-wetting.

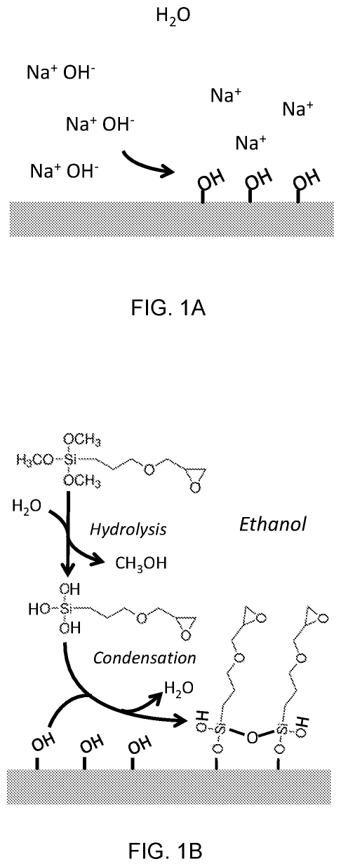

Silane coatings are typically prepared from trialkoxysilanes that include three possible binding sites for binding with the substrate, which facilitates efficient grafting onto the target surface (FIGS. 1A and 1B). The present disclosure provides a silanization method with improved efficiency. The methods of the present disclosure may be used with trialkoxysilanes, dialkoxysilanes, monoalkoxysilanes, and combinations thereof.

It has been found that the resulting covalent attachments to the substrate are susceptible to hydrolysis. As a result, silanized surfaces may suffer from poor stability in aqueous environments, such as within a human body. It would, therefore, be desirable to provide a silane coating that has increased stability.

According to an embodiment, a method of silanizing a surface of a substrate includes preparing a reagent solution comprising one or more alkoxysilanes by lowering a pH of the reagent solution to pH 1 to 6.5. The pH of the reagent solution is subsequently increased to pH 4 to 8. The surface that is to be silanized may be activating the surface to introduce reactive groups. Alternatively, the surface may already include reactive groups and may not need to be activated. The surface including reactive groups (e.g., the activated surface) is contacted with the reagent solution. The surface is subsequently dried to cure the silane coating.

According to an embodiment, the coatings of the present disclosure may be applied onto the surface of any suitable substrate, as long as the surface has or can be modified to have hydroxyl groups or other chemical groups capable of undergoing condensation reaction. Suitable substrates include various metals, minerals, and polymers. According to an embodiment, the coating is applied onto a metal substrate, such as nitinol, titanium (e.g., sintered titanium), steel (e.g., stainless steel), nitride, cobalt, chromium, cobalt chromium, platinum, or alloys thereof. In one specific embodiment, the coating is applied onto a nitinol substrate. In some embodiments, the coating is applied onto non-metal substrates, such as a polymeric substrate or a ceramic substrate. In embodiments, where the coating is applied to a polymeric substrate, a polymeric substrate that is resistant to solvents may be selected. Non-limiting examples of such plastics include polycarbonate, polycarbonate-urethane, polyurethane, polyethylene, polypropylene, and the like.

Without wishing to be bound by theory, it is believed that silanes with fewer binding sites may form covalent bonds with the substrate that are more stable in aqueous conditions, such as when implanted into the body of a patient. Silanes having one or two of the alkoxy groups (e.g., methoxy groups) replaced by an alkyl group (e.g., methyl or ethyl group) may be more stable in aqueous conditions in some circumstances. Furthermore, in certain applications, it may be undesirable to form a highly crosslinked silane network. Silane coatings prepared from mono- or di-alkoxysilanes may be less capable of forming crosslinked silane networks on the material surface. It has also been found that the methods of the present disclosure are capable of forming a thicker coating than prior art methods when using trialkoxysilanes.

According to an embodiment, a substrate is silanized using alkoxysilanes. The substrate may be silanized using monoalkoxysilanes, dialkoxysilanes, trialkoxysilanes, or a combination thereof. The substrate may be silanized using monoalkoxysilanes or dialkoxysilanes or a combination thereof. The substrate may be part of a medical device, such as an implantable device. The substrate may include a metal or a polymer. In some embodiments, the substrate is or includes nitinol.

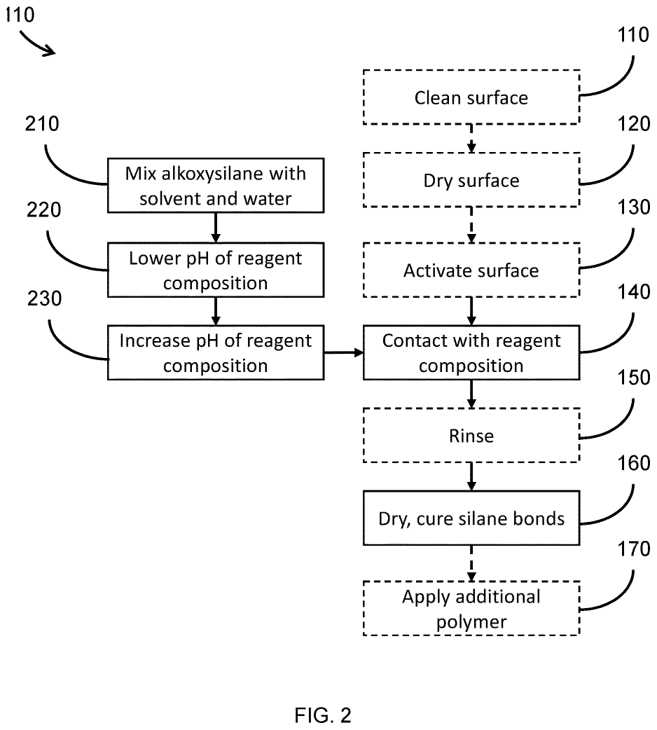

A schematic flow diagram of the method 100 of the present disclosure is shown in FIG. 2. A reagent composition containing the alkoxysilane may be prepared by dissolving the alkoxysilane in an organic solvent and water in step 210. It may be beneficial to control the amount of water present in the solution, as alkoxysilanes may be hydrolyzed in the presence of water. The amount of water may be from 0.5 vol-% to 50 vol-% water, from 1 vol-% to 10 vol-%, or from 2 vol-% to 8 vol-% water by weight of the reagent composition. As described herein, the solvent may be polar, and may have an acidic pH to drive alkoxysilane hydrolysis. The pH of the reagent composition containing the alkoxysilane is lowered in step 220 to drive alkoxysilane hydrolysis in preparation for the silanization reaction. The pH may be lowered to pH 1 to 6.5, 1 to 6, 1.5 to 5, 1.5 to 4, or 1.5 to 3. In step 230, the pH may be increased to pH 4 to 8, 5 to 8, or 6 to 7.5 to form a prepared reagent composition. The time between lowering and increasing the pH may be 10 minutes or greater, 30 minutes or greater, or 1 hour or greater. The time between lowering and increasing the pH is not particularly limited, and the reagent composition may be stored at the lower pH. In practice, the time between lowering and increasing the pH may be up to 1 month, up to 1 week, up to 1 day, up to 12 hours, up to 6 hours, up to 4 hours, up to 3 hours, or up to 2 hours. The time between the increasing of pH and the silanization reaction with the substrate may be limited to 24 hours or less, 12 hours or less, 8 hours or less, 4 hours or less, or 2 hours or less.

The substrate may be prepared by cleaning and drying the surface 110, 120. The substrate may be cleaned to remove contamination and expose the bare substrate surface, for example, with a detergent, a solvent, UV light, heat, or plasma, such as oxygen plasma. The substrate may be dried, for example, using heat and/or vacuum. According to an embodiment, the surface of the substrate is then activated 130 to become capable of undergoing condensation reactions with silane. Activation of the surface may include forming hydroxyl groups on the surface, as shown in FIG. 1A. The substrate may include a metal, such as nitinol, titanium, cobalt chromium, steel, or another suitable substrate. The surface (e.g., surface of nitinol) may be activated using any suitable method, such as using oxygen plasma. In some embodiments, the surface is activated with a base, such as sodium hydroxide. If the substrate is a material that is already or inherently capable of undergoing condensation reactions with silanol, the activation step may be omitted.

The surface of the substrate (e.g., the activated surface, such as an activated nitinol surface) is then contacted with the prepared reagent composition in step 140. The contacting may be performed in any suitable way. For example, the activated surface may be immersed in the reagent composition. According to an embodiment, the activated surface may be immersed in the reagent composition for a predetermined amount of time. The activated surface may be immersed in the reagent composition for 0.5 second or more, 1 second or more, 10 seconds or more, 30 seconds or more, 1 minute or more, 2 minutes or more, 3 minutes or more, 4 minutes or more, or 5 minutes or more. The activated surface may be immersed in the silane solution for 10 minutes or less, 9 minutes or less, 8 minutes or less, 7 minutes or less, 6 minutes or less, 5 minutes or less, 2 minutes or less, 1 minute or less, or 30 seconds or less.

The alkoxysilane may be a monoalkoxysilane, dialkoxysilane, trialkoxysilane, or a combination thereof. The activated surface is contacted with a solution including monoalkoxysilanes, dialkoxysilanes, trialkoxysilanes, or a combination thereof. The solution may be free or substantially free of trialkoxysilanes. The solution may be an aqueous solution that includes an organic solvent. Any suitable polar organic solvent may be used, such as ethanol, isopropyl alcohol, methanol, acetonitrile, acetone, DMSO, DMF, or the like. In some embodiments, the solvent is ethanol. In some embodiments, the solution includes or is ethanol and water.

According to an embodiment, the amount of water in the solution is controlled to achieve consistent grafting of the silanes to the surface. The amount of water in the solution may be 0.5 vol-% or greater, 1 vol-% or greater, 2 vol-% or greater, 3 vol-% or greater, or 4 vol-% or greater. The amount of water may be 80 vol-% or less, 50 vol-% or less, 40 vol-% or less, 30 vol-% or less, 25 vol-% or less, 20 vol-% or less, 15 vol-% or less, or 10 vol-% or less. The amount of water in the solution may be from 0.5 vol-% to 50 vol-% water, from 1 vol-% to 10 vol-%, or from 2 vol-% to 8 vol-% water. The balance of the solution may be organic solvent. Many organic solvents may be compatible with this approach. According to an embodiment, the organic solvent may be polar. According to an embodiment, the organic solvent is miscible or partly miscible with water. Suitable organic solvents include isopropanol, ethanol, methanol, or the like.

The alkoxysilane reagent may be prepared by lowering the pH or adding water to the reagent or both to hydrolyze the silanes. In some embodiments, the pH of the reagent solution is lowered to a pH 1 or greater, 1.5 or greater, or 2 or greater. The pH of the reagent solution may be lowered to a pH of 6.5 or lower, 6 or lower, 5 or lower, 4 or lower, or 3 or lower. The pH of the reagent solution may be lowered to a pH of 1 to 6.5, 1 to 6, 1.5 to 5, 1.5 to 4, or 1.5 to 3. In some embodiments, the pH of the reagent solution may be lowered to a pH of about 2. The pH of the reagent solution may again be increased (e.g., neutralized) before or at the time of performing the silanization reaction. The pH of the reagent solution may be increased to pH 4 or greater, 5 or greater, or 6 or greater. The pH of the reagent solution may be increased to pH of 8 or lower or 7.5 or lower. The pH of the reagent solution may be increased to pH 4 to 8, 5 to 8, or 6 to 7.5. According to an embodiment, the solution during silanization has a neutral pH. The pH may be from 5 to 9, from 6 to 8, or about 7. The pH of the solution may be adjusted using an acid, a base, or both. Any suitable acids and/or bases may be used to achieve the desired pH. The steps of lowering and increasing the pH are not particularly limited by the specific acid or base used to perform the pH adjustments. Preferably, the acid and base are selected such that they do not interfere with the silanization reaction. In some embodiments, the pH is adjusted down using hydrochloric acid, nitric acid, or the like. In some embodiments, the pH is adjusted up using sodium hydroxide, potassium hydroxide, sodium carbonate, ammonia, or the like. The silanization reaction may be manipulated to increase or decrease the concentration of silanes on the surface. As described herein, the concentration of silanes on the surface may impact the concentration of subsequently attached polymers. In some cases, a higher concentration of subsequently attached polymer may be desired. The concentration of silanes on the surface may be impacted by the method of surface activation used. The concentration of silanes on the surface may be impacted by, for example, modifying the conditions used to dry the coating, increasing the amount of time the substrate is submerged in the solution, or other methods. According to an embodiment, the methods of the present disclosure provide a sufficiently high concentration for attaching a coating (e.g., a polymer), relative to the available bonding sites on the coating molecules. The grafting density of silane or an additional coating (e.g., polymer) on the surface correlates with elemental analysis on the surface. Elemental analysis (e.g., concentration of silane or an element present in the additional coating) of the surface may be performed, for example, by using XPS/ESCA (X-ray Photoelectron Spectroscopy (XPS) also known as Electron Spectroscopy for Chemical Analysis (ESCA)) or ellipsometry. The concentration, which correlates with grafting density, may be expressed as an atomic percentage of silicon or the other element on the surface.

The conditions of the grafting reaction may be manipulated according to the silane used. For example, in embodiments wherein a monoalkoxysilane is used, the reaction duration and temperature may be increased relative to the temperature and duration of a comparable reaction using a trialkoxysilane.

Silanes are typically grafted onto the surface in a condensation reaction with free hydroxyl groups present on an activated surface. Thus, methods suitable to improving the efficiency of condensation reactions may be used to improve the efficiency of silane grafting. According to an embodiment, the reaction may occur at elevated temperature.

Increasing the reaction temperature may improve the efficiency of silane grafting.

According to an embodiment, the reaction may occur in a vacuum. Performing the reaction in a vacuum may improve the efficiency of silane grafting.

According to an embodiment, a thin film deposition technique is used to graft the silane onto the surface. Thin film deposition techniques typically result in a thin, uniform layer of a compound on a substrate. This may advantageously improve the uniformity of the coating formed.

Alkoxysilanes can generally be represented by Formula (I):

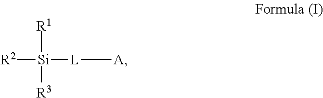

where A is a functional group, L is a linker, and R¹, R², and R³ are independently alkoxyl or alkyl groups, at least one of R¹, R², and R³ being an alkoxyl group.

In typical silane coatings, each of R¹, R², and R³ is an alkoxyl group and the silane is a trialkoxysilane. Typical alkoxyl groups include methoxyl and ethoxyl groups. In some embodiments, one or two of R¹, R², and R³ are alkyl groups and the remaining one or two are alkoxyl groups. According to some embodiments of the present disclosure, the silane is a monoalkoxysilane or dialkoxysilane. The alkyl groups may be straight, branched, or cyclic. The alkyl groups may be substituted with one or more hetero atoms, such as N or S. In some embodiments, the alkyl groups are straight and unsubstituted. In some embodiments, the alkyl groups include 1 to 6 carbon atoms, 1 to 4 carbon atoms, 1 to 3 carbon atoms, or 1 or 2 carbon atoms. Suitable alkyl groups include methyl, ethyl, and propyl groups. Suitable alkoxyl groups include methoxyl, ethoxyl, propoxyl. In some embodiments, the alkoxyl group may include a chain of multiple alkoxyl moieties. For example, the alkoxyl may be methoxydiethylenoxyl (CH₃OCH₂CH₂OCH₂CH₂O—). In one embodiment, one or two of R¹, R², and R³ are independently selected from methyl and ethyl. In one embodiment, one or two of R¹, R², and R³ are methyl. In one embodiment, one or two of R¹, R², and R³ are ethyl. The remaining one or two of R¹, R², and R³ may be independently methoxyl, ethoxyl, or propoxyl. Typically, the alkoxyl group may be hydrolyzed and reacted with an activated surface. Often, the activated surface includes free hydroxyl groups, thus, the silane is able to react with a hydroxyl group.

For example, in one specific embodiment, the alkoxyl group is methoxyl and the silane is represented by Formula (IA):

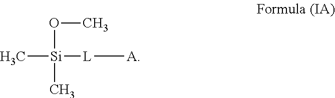

In another embodiment, the silane is represented by Formula (IB):

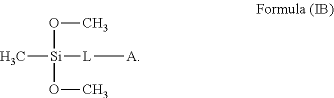

In another embodiment, the silane is represented by Formula (IC):

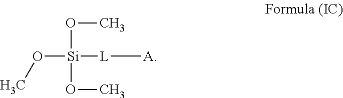

The methoxyl group in Formulas IA, IB, and IC may be traded for other alkoxyl groups to form analogous mono-, di-, and trialkoxysilanes.

The silane may include two types of functional moieties. The first functional moiety of the silane is typically one, two, or three alkoxyl groups, as described herein. The second functional moiety (functional group A) may be compatible with a reactive group of an additional coating molecule. Alternatively, the second functional moiety may be used to present a desirable new property or chemical functionality for the material surface. The functional groups may be separated by any suitable distance. In embodiments wherein the functional groups are separated by a linker, the linker may have one or more carbon atoms or oxygen atoms.

The functional group A may be any suitable group that can provide a desired property to the substrate or may be used to react with another molecule to introduce a chemical functionality to the substrate. For example, the functional group may facilitate grafting an additional coating onto the silane. In some embodiments, the functional group is an electrophile. Examples of suitable functional groups include alkyls, epoxides, carboxylic acids, halides, acrylates, alkoxyls, cyanates, thiols, and amines. The functional group A may be selected based on a desired surface property. The functional group A may be selected based on the reactivity of an additional coating to be grafted to the silane. For example, in embodiments wherein the additional coating includes a reactive nucleophile, the functional group A may be an electrophile.

In some embodiments, the functional group A includes an epoxide ring. For example, functional group A may be an epoxide, such as glycidyl. In some embodiments, the epoxide may be part of a dicyclic group, such as epoxycyclohexane. Epoxide functional silanes may be represented by Formula (IIA):

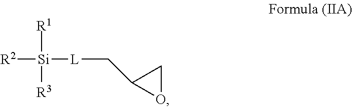

where R¹, R², and R³ are independently alkoxyl or alkyl groups and L is a linker as described above in reference to Formula (I).

Examples of epoxide functional silanes include (3-glycidyloxypropyl) methoxydimethylsilane (GPMS) represented by Formula (IIA-1), (3-glycidyloxypropyl) dimethoxymethylsilane (GPDS) represented by Formula (IIA-2), and (3-glycidyloxypropyl) trimethoxysilane (GPTS) represented by Formula (IIA-3), where the alkoxyl group is methoxyl, the alkyl is methyl, and the linker L is propoxyl:

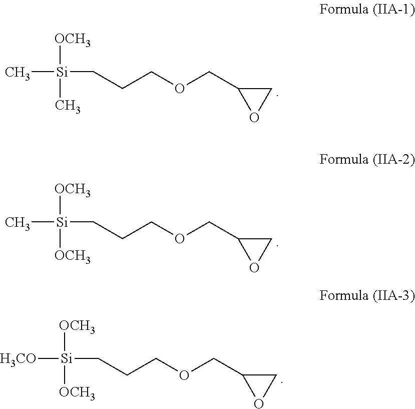

In some embodiments, the functional group A includes an alkyl. The alkyl may have any suitable number of carbon atoms to convey a desired surface property. In some cases, the alkyl may be selected to provide a hydrophobic property to the surface. The alkyl may have 6 to 32, 8 to 24, or 10 to 20 carbon atoms. Alkyl functional silanes may be represented by Formula (IIB):

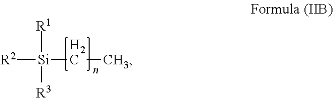

where R¹, R², and R³ are independently alkoxyl or alkyl groups as described above in reference to Formula (I), and where (n+1) is 6 to 32, 8 to 24, or 10 to 20.

An example of a silane with a 12-carbon alkyl chain is n-dodecyltrimethoxysilane, represented by Formula (IIB-1):

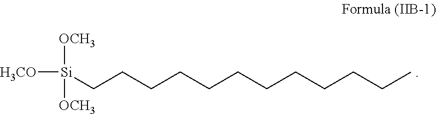 [SMILES: CCCCCCCCCCCC[Si](OC)(OC)OC]

In some embodiments, the functional group A includes a halide. Halide functional silanes may be represented by Formula (IIC):

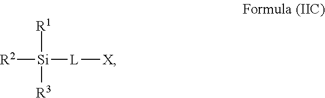

where R¹, R², and R³ are independently alkoxyl or alkyl groups and L is a linker as described above in reference to Formula (I), and where X is a halide, such as Cl, F, Br, or I.

An example of a silane with a halide functional group is 3-chloropropylmethyldimethoxysilane, represented by Formula (IIC-1):

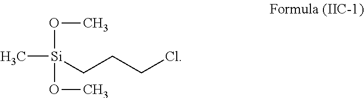

In some embodiments, the functional group A includes a (meth)acrylate. Acrylate functional silanes may be represented by Formula (IID):

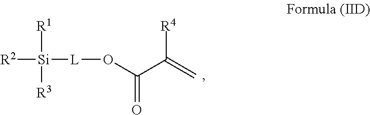

where R¹, R², and R³ are independently alkoxyl or alkyl groups and L is a linker as described above in reference to Formula (I), and where R⁴ is H or CH₃.

An example of a silane with a methacrylate functional group is (methacryloxymethyl)methyldimethoxysilane, represented by Formula (IID-1):

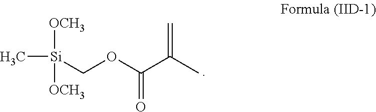

In some embodiments, the functional group A includes a cyanate group. Cyanate functional silanes may be represented by Formula (IIE):

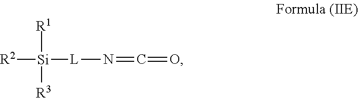

where R¹, R², and R³ are independently alkoxyl or alkyl groups and L is a linker as described above in reference to Formula (I).

An example of a silane with a cyanate group is (isocyanatomethyl)methyldimethoxysilane, represented by Formula (IIE-1):

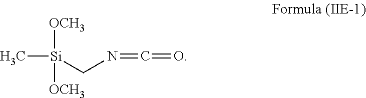

In some embodiments, the functional group A includes a thiol. Thiol functional silanes may be represented by Formula (IIF):

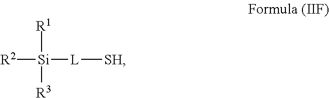

where R¹, R², and R³ are independently alkoxyl or alkyl groups and L is a linker as described above in reference to Formula (I).

An example of a silane with a thiol group is (3-mercaptopropyl)methyldimethoxysilane, represented by Formula (IIE-1):

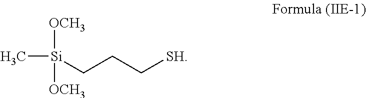

In some embodiments, the functional group A includes an amine. The amine may be protected by a protecting group that may be removed prior to grafting another coating molecule to the silane. Amine functional silanes may be represented by Formula (IIG):

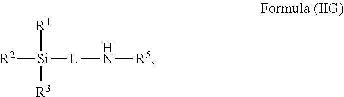

where R¹, R², and R³ are independently alkoxyl or alkyl groups and L is a linker as described above in reference to Formula (I), and where R⁵ is H or a protecting group, such as t-butyloxycarbonyl (Boc) carboxybenzyl (CBz), or fluorenylmethoxy (Fmoc).

An example of a silane with a protected amino group is (3-triethoxysilylpropyl)-t-butylcarbamate, represented by Formula (IIG-1):

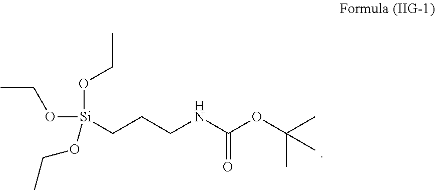 [SMILES: CCO[Si](CCCNC(=O)OC(C)(C)C)(OCC)OCC]

The linker L may be carbon-containing group, such as an alkyl or alkoxy. Linker L may include heteroatoms, such as oxygen, nitrogen, or sulfur. The linker L may be saturated or unsaturated. The linker L may be linear, branched, and may include cyclic groups, including aromatic groups. In some embodiments, when linker L is branched, one or more branches or each branch may terminate in a reactive group, such as functional group A. Specific examples of suitable linkers include alkyls, alkoxyls, polyethylene glycol repeats (e.g., PEG2, PEG4, PEG6), phenyl, and combinations thereof. In some preferred embodiments, the linker L is inert in the conditions present during the silanization and the intended use of the silanized article. In some embodiments, L has up to 20 carbon atoms, up to 10 carbon atoms, 1 to 5 carbon atoms, 1 to 4 carbon atoms, 1 to 3 carbon atoms, or 1 or 2 carbon atoms. In some embodiments, L is an alkyl containing up to 20 carbon atoms, 1 to 5 carbon atoms, 1 to 4 carbon atoms, 1 to 3 carbon atoms, or 1 or 2 carbon atoms. The linker L may be inert, such as (CH₂)ₙ. In some embodiments, L is a halogen-substituted alkyl, such as fluorinated alkyl. In some embodiments, L is a carbon chain including heteroatoms, particularly nitrogen, sulfur, or oxygen. An example of such a linker is (CH₂)₂NH(CH₂)₂. The nitrogen within a carbon chain may be NH or NR, where R is any alkyl group, preferably methyl or ethyl. In embodiments wherein linker L includes nitrogen, it may include one or more nitrogen atoms. In embodiments, linker L includes a charge. In particular, linker L may include a positively charged nitrogen within an alkyl chain. An example of such a linker is present in 3-(N-styrylmethyl-2-aminoethylamino)propyltrimethoxysilane hydrochloride. In some embodiments, L is absent and the functional group A is directly linked to the silicon atom.

In some embodiments, the linker L is an alkyl. Such silanes may be represented by Formula (IIIA):

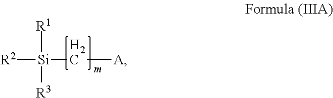

where R¹, R², and R³ are independently alkoxyl or alkyl groups and A is a functional group as described above in reference to Formula (I), and m is an integer from 1 to 20, from 1 to 10, from 1 to 5, from 1 to 4, from 1 to 3, or from 1 to 2.

An example of a silane with an alkyl linker is 3-chloropropyldimethylmethoxysilane, represented by Formula (IIIA-1):

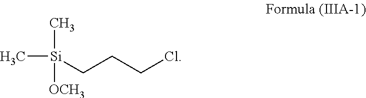

In some embodiments, the linker L is a phenyl group. Such silanes may be represented by Formula (IIIB):

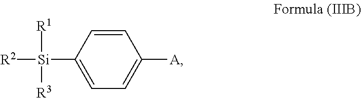

where R¹, R², and R³ are independently alkoxyl or alkyl groups and A is a functional group as described above in reference to Formula (I), and m is an integer from 1 to 20, from 1 to 10, from 1 to 5, from 1 to 4, from 1 to 3, or from 1 to 2.

An example of a silane with an alkyl linker is dimethylmethoxy(4-chlorophenyl)silane, represented by Formula (IIJ-1):

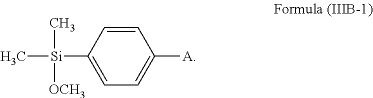

Specific examples of suitable silanes, some of which are shown above, include (3-glycidyloxypropyl) methoxydimethylsilane, (3-mercaptopropyl)methyldimethoxysilane, dimethylmethoxy(4-chlorophenyl)silane, 3-chloropropylmethyldimethoxysilane, 3-acetoxypropylmethyldimethoxysilane, 2,2-dimethoxy-1-thia-2-silacyclopentane, (methacryloxymethyl)methyldimethoxysilane, methoxydiethylenoxypropyldimethylchlorosilane, n-dodecyltrimethoxysilane, 3-glycidoxypropyltrimethoxysilane, 2-(3,4-epoxycyclohexyl)ethyl-triethoxysilane, 2-(3,4-epoxycyclohexyl)ethyl-trimethoxysilane, (3-glycidoxypropyl)trimethoxysilane, (3-glycidoxypropyl)triethoxysilane, 5,6-epoxyhexyltri-ethoxysilane, 3-isocyanatopropyltriethoxysilane, (isocyanatomethyl)methyldimethoxysilane, 3-isocyanatopropyltrimethoxysilane, tris(3-trimethoxysilylpropylisocyanurate, (3-triethoxysilylpropyl)-t-butylcarbamate, triethoxysilylpropylethylcarbamate, 3-thiocyanatopropyltriethoxysilane, 3-acrylamidopropyltrimethoxysilane, N-(3-acryloxy-2-hydroxypropyl)-3-aminopropyltriethoxysilane, acryloxymethyltrimethoxysilane, (acryloxymethyl)phenethyltrimethoxysilane, (3-acryloxypropyl)trimethoxysilane, O-(3-methacryloxy-2-hydroxypropyl)-3-aminopropyltriethoxysilane, methacryloxymethyltriethoxysilane, methacryloxymethyltrimethoxysilane, methacryloxypropyltriethoxysilane, methacryloxypropyltrimethoxysilane, triethoxysilylbutyraldehyde, triethoxysilylundecanal, 4-aminobutyltriethoxysilane, 4-amino-3,3-dimethylbutyltrimethoxysilane, N-(2-aminoethyl)-3-aminopropyltriethoxysilane, p-aminophenyltrimethoxysilane, 3-aminopropyltriethoxysilane, N-(3-trimethoxysilylpropyl)pyrrole, N-(2-aminoethyl)-3-aminopropyltrimethoxysilane, N, N-bis(2-hydroxyethyl)-3-aminopropyltriethoxysilane, acetoxymethyltriethoxysilane, acetoxymethyltrimethoxysilane, 2-(carbomethyoxy)ethyltrimethoxysilane, 3-bromopropyltrimethoxysilane, (p-chloromethyl)phenyltrimethoxysilane, 3-chloropropyltriethoxysilane, (2-diethylphosphateoethyl)triethoxysilane, 3-mercaptopropyltriethoxysilane, 2-(3-trimethoxysilylpropylthio)thiophene, (3-acryloxypropyl)methyldiethoxysilane, (3-acryloxypropyl)methyldimethoxysilane, (methacryloxymethyl)methyldiethoxysilane, (methacryloxymethyl)methyldimethoxysilane, methacryloxypropylmethyldiethoxysilane, methacryloxypropylmethyldimethoxysilane, 4-amino-3,3-dimethylbutylmethyldimethoxysilane, 3-aminopropylmethyldiethoxysilane, N-(2-aminoethyl)-3-aminoisobutylmethyldimethoxysilane, N-(2-aminoethyl)-3-aminopropylmethyldiethoxysilane, chloromethylmethyldiethoxysilane, 3-chloropropylmethyldimethoxysilane, (mercaptomethyl)methyldiethoxysilane, 3-mercaptopropylmethyldimethoxysilane, (3-acryloxypropyl)dimethylmethoxysilane, (methacryloxymethyl)dimethylethoxysilane, methacryloxypropyldimethylmethoxysilane, 3-aminopropylmethyldiethoxysilane, 3-aminopropyldimethylethoxysilane, N-(2-aminoethyl)-3-aminoisobutyldimethylmethoxysilane, 3-chloroisobutyldimethylmethoxysilane, and combinations thereof.

Referring again to FIG. 2, after contacting with the reagent composition, the activated surface is optionally rinsed, 150. The surface may be rinsed using the same solvent or combination of solvents used to dissolve the silane, or it may be rinsed in a different solvent. In some embodiments, the rinsing step may be omitted.

Following contacting with the reagent composition and optionally rinsing, the surface is dried, and the siloxane bonds are cured, 160. According to an embodiment, the surface is dried under vacuum. According to an embodiment, the surface is dried at a high temperature. The drying temperature may be 90° C. or more, 100° C. or more, 125° C. or more, or 150° C. or more. The drying temperature may be 200° C. or less, 175° C. or less, 150° C. or less, or 125° C. or less. The drying temperature may be, for example, from 100° C. to 150° C., such as approximately 110° C.

According to an embodiment, the method may optionally further include attachment of a molecule to the functional group A of the silane, 170. The molecule may be any suitable molecule capable of reacting with the functional group A and providing a desired property. The molecule may be, for example, a protein or other polymer. This reaction may additionally be a nucleophilic substitution reaction, such as an S_{N}2 reaction. As described herein, the efficiency of the reaction may be increased by, for example, increasing the reaction temperature or performing the reaction in a vacuum.

Any suitable molecule may be attached to the functional group A of the silane. In some embodiments, the functional group A includes a reactive moiety that is capable of reacting with a reactive moiety on the molecule to be grafted. The molecule may be selected to achieve a desirable surface property. In some embodiments, a polymer is attached to the silane that provides one or more properties, such as anti-fouling, low friction, lubrication, adhesion promotion, hydrophobicity, hydrophilicity, non-wetting, or the like.

According to an embodiment, the polymer may be a zwitterionic polymer. The polymer may include a phospholipid moiety, and may further include phosphorylcholine.

In some specific embodiments, the polymer may confer thromboresistance to blood-contacting surfaces or an article. Examples of suitable phosphorylcholines include 2-methacryloyloxyethyl phosphorylcholine, 2-acryloyloxyethyl phosphorylcholine, and phosphorylcholines based on monomers such as 2-(meth)acryloyloxyethyl-2′-(trimethylammonio)ethyl phosphate, 3-(meth)acryloyloxypropyl-2′-(trimethylammonio)ethyl phosphate, 4-(meth)acryloyloxybutyl-2′-(trimethylammonio)ethyl phosphate, 5-(meth)acryloyloxypentyl-2′-(trimethylammonio)ethyl phosphate, 6-(meth)acryloyloxyhexyl-2′-(trimethylammonio)ethyl phosphate, 2-(meth)acryloyloxyethyl-2′-(triethylammonio)ethyl phosphate, 2-(meth)acryloyloxyethyl-2′-(tripropylammonio)ethyl phosphate, 2-(meth)acryloyloxyethyl-2′-(tributylammonio)ethyl phosphate, 2-(meth)acryloyloxypropyl-2′-(trimethylammonio)ethyl phosphate, 2-(meth)acryloyloxybutyl-2′-(trimethylammonio)ethyl phosphate, 2-(meth)acryloyloxypentyl-2′-(trimethylammonio)ethyl phosphate, 2-(meth)acryloyloxyhexyl-2′-(trimethylammonio)ethyl phosphate, 2-(meth)acryloyloxyethyl-3′-(trimethylammonio)propyl phosphate, 3-(meth)acryloyloxypropyl-3′-(trimethylammonio)propyl phosphate, 4-(meth)acryloyloxybutyl-3′-(trimethylammonio)propyl phosphate, 5-(meth)acryloyloxypentyl-3′-(trimethylammonio)propyl phosphate, 6-(meth)acryloyloxyhexyl-3′-(trimethylammonio)propyl phosphate, 2-(meth)acryloyloxyethyl-4-(trimethylammonio)butyl phosphate, 3-(meth)acryloyloxypropyl-4′-(trimethylammonio)butyl phosphate, 4-(meth)acryloyloxybutyl-4′-(trimethylammonio)butyl phosphate, 5-(meth)acryloyloxypentyl-4′-(trimethylammonio)butyl phosphate, 6-(meth)acryloyloxyhexyl-4′-(trimethylammonio)butyl phosphate, and combinations thereof.

In some embodiments, the coating is an anti-fouling coating. Anti-fouling coatings may be applied, for example, to implantable medical devices. An example of a suitable anti-fouling coating molecule is PEG.

According to an embodiment, the methods of the present disclosure may be used to prepare coated substrates. The coated substrate may include a silane coating. The coated substrate may further include an additional coating grafted onto the silane coating. The substrate may include a surface and a silane coating grafted onto the surface, where the silane coating includes silanes prepared from one or more monoalkoxysilanes, dialkoxysilanes, or a combination thereof. The silane density of the coating correlates with silicon elemental concentration, which may be measured using XPS/ESCA, and may be expressed as an atomic percentage of silicon on the surface. The coating may exhibit a silicon elemental concentration of 0.5 atomic % or more, 0.6 atomic % or more, 0.7 atomic % or more, 0.8 atomic % or more, 0.9 atomic % or more, 1 atomic % or more, 2 atomic % or more, 3 atomic % or more, or 4 atomic % or more. When the silane coating is made using monoalkoxysilanes, the coating may exhibit a silicon elemental concentration of 0.5 atomic % or more, 0.6 atomic % or more, 0.7 atomic % or more, 0.8 atomic % or more, 0.9 atomic % or more, or 1 atomic % or more. When the silane coating is made using dialkoxysilanes, the coating may exhibit a silicon elemental concentration of 1 atomic % or more, 2 atomic % or more, 3 atomic % or more, or 4 atomic % or more. The silicon elemental concentration may be 8 atomic % or less, or 6 atomic % or less. Coating thickness may also be measured using ellipsometry.

The silanes may be represented by Formula (I):

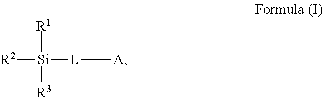

where L is a linker, A is a reactive group, R¹, R², and R³ are independently alkoxyl or alkyl groups, where one or two of R¹, R², and R³ is an alkoxyl group and one or two of R¹, R², and R³ comprise an alkyl having 1 to 6 carbon atoms. The alkyl may be straight, branched, or cyclic. The alkyl may optionally be substituted with one or more hetero atoms, such as N or S. The alkyl groups may independently be methyl, ethyl, or propyl.

### EMBODIMENTS

A list of exemplary embodiments is provided below.

Embodiment 1 is a method of silanizing a surface of a substrate, the method comprising:
preparing a reagent solution comprising one or more alkoxysilanes by lowering a pH of the reagent solution to pH 1 to 6.5;
increasing the pH of the reagent solution to pH 4 to 8;
activating the surface to introduce reactive groups;
contacting the activated surface with the reagent solution; and drying the surface.

Embodiment 2 is the method of embodiment 30, wherein the alkoxysilanes comprise monoalkoxysilanes, dialkoxysilanes, or a combination thereof.

Embodiment 3 is a method of silanizing a surface of a substrate, the method comprising:
activating the surface to introduce reactive groups;
contacting the activated surface with a reagent solution comprising monoalkoxysilanes, dialkoxysilanes, or a combination thereof; and
drying the surface.

Embodiment 4 is the method of any one of embodiments 1 to 3, wherein the reactive groups are hydroxyl groups.

Embodiment 5 is the method of any one of embodiments 1 to 4, wherein the surface is activated using an activation solution comprising water and a base.

Embodiment 6 is the method of any one of embodiments 1 to 4, wherein the surface is activated using plasma.

Embodiment 7 is the method of embodiment 6, wherein the plasma is oxygen plasma.

Embodiment 8 is the method of any one of embodiments 1 to 7, wherein the substrate comprises a metal, optionally wherein the metal comprises nitinol, titanium, cobalt chromium, or steel.

Embodiment 9 is the method of any one of embodiments 1 to 8, wherein the reagent solution comprises an alcohol and water.

Embodiment 10 is the method of embodiment 7, wherein the alcohol is selected from ethanol, methanol, isopropanol, and combinations thereof.

Embodiment 11 is the method of any one of embodiments 1 to 10, wherein the reagent solution comprises from 0.5 vol-% to 50 vol-% water, from 1 vol-% to 10 vol-%, or from 2 vol-% to 8 vol-% water, optionally with the balance of alcohol.

Embodiment 12 is the method of any one of embodiments 1 to 11, wherein the reagent solution has a pH from 4.5 to 8, 6 to 8, or about 7 when contacting with the surface.

Embodiment 13 is the method of any one of embodiments 1 to 12, wherein the method results in a silicon content of 0.5 atomic % or greater, 0.6 atomic % or more, 0.7 atomic % or more, 0.8 atomic % or more, 0.9 atomic % or more, 1 atomic % or more, 2 atomic % or more, 3 atomic % or more, or 4 atomic % or more on the surface. In an embodiment, the silane coating is made using monoalkoxysilanes and the coating may exhibit a silicon elemental concentration of 0.5 atomic % or more, 0.6 atomic % or more, 0.7 atomic % or more, 0.8 atomic % or more, 0.9 atomic % or more, or 1 atomic % or more. In an embodiment, the silane coating is made using dialkoxysilanes, and the coating may exhibit a silicon elemental concentration of 1 atomic % or more, 2 atomic % or more, 3 atomic % or more, or 4 atomic % or more. The silicon elemental concentration may be 8 atomic % or less, or 6 atomic % or less.

Embodiment 14 is the method of any one of embodiments 1 to 13, wherein drying occurs in a vacuum.

Embodiment 15 is the method of any one of embodiments 1 to 14, wherein drying occurs at a temperature 90° C. or more, 100° C. or more, 125° C. or more, or 150° C. or more. The drying temperature may be 200° C. or less, 175° C. or less, 150° C. or less, or 125° C. or less. The drying temperature may be, for example, from 100° C. to 150° C., or approximately 110° C.

Embodiment 16 is the method of any one of embodiments 1 to 15, wherein the reagent solution comprises monoalkoxysilanes represented by Formula (I):

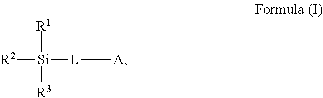

wherein L is a linker, A is a functional group, R¹, R², and R³ are independently alkoxyl or alkyl groups, at least one of R¹, R², and R³ being an alkoxyl group.

Embodiment 17 is the method of embodiment 16, wherein the reagent solution comprises monoalkoxysilanes, and wherein R1 is methoxyl, ethoxyl, or propoxyl.

Embodiment 18 is the method of embodiment 16 or 17, wherein functional group A comprises an epoxide, a carboxylic acid, a halide, a (meth)acrylate, an alkoxyl, a cyanate, a thiol, or an amine.

Embodiment 19 is the method of any one of embodiments 1 to 18, wherein linker L comprises a carbon-containing group with up to 20 carbon atoms, up to 10 carbon atoms, 1 to 5 carbon atoms, 1 to 4 carbon atoms, 1 to 3 carbon atoms, or 1 or 2 carbon atoms, optionally comprising one or more heteroatoms selected from oxygen, nitrogen, and sulfur, wherein linker L is saturated or unsaturated, and wherein linker L is linear, branched, and optionally includes one or more cyclic groups.

Embodiment 20 is the method of embodiment 19, wherein linker L comprises an alkyl, alkoxyl, one or more polyethylene glycol repeats, phenyl, or a combination thereof.

Embodiment 21 is the method of any one of embodiments 1 to 20, wherein the reagent solution is free or substantially free of trialkoxysilanes.

Embodiment 22 is the method of any one of embodiments 1 to 20, wherein the alkoxysilanes comprise (3-glycidyloxypropyl) methoxydimethylsilane, (3-mercaptopropyl)methyldimethoxysilane, dimethylmethoxy(4-chlorophenyl)silane, 3-chloropropylmethyldimethoxysilane, 3-acetoxypropylmethyldimethoxysilane, 2,2-dimethoxy-1-thia-2-silacyclopentane, (methacryloxymethyl)methyldimethoxysilane, methoxydiethylenoxypropyldimethylchlorosilane, n-dodecyltrimethoxysilane, 3-glycidoxypropyltrimethoxysilane, 2-(3,4-epoxycyclohexyl)ethyl-triethoxysilane, 2-(3,4-epoxycyclohexyl)ethyl-trimethoxysilane, (3-glycidoxypropyl)trimethoxysilane, (3-glycidoxypropyl)triethoxysilane, 5,6-epoxyhexyltri-ethoxysilane, 3-isocyanatopropyltriethoxysilane, (isocyanatomethyl)methyldimethoxysilane, 3-isocyanatopropyltrimethoxysilane, tris(3-trimethoxysilylpropylisocyanurate, (3-triethoxysilylpropyl)-t-butylcarbamate, triethoxysilylpropylethylcarbamate, 3-thiocyanatopropyltriethoxysilane, 3-acrylamidopropyltrimethoxysilane, N-(3-acryloxy-2-hydroxypropyl)-3-aminopropyltriethoxysilane, acryloxymethyltrimethoxysilane, (acryloxymethyl)phenethyltrimethoxysilane, (3-acryloxypropyl)trimethoxysilane, O-(3-methacryloxy-2-hydroxypropyl)-3-aminopropyltriethoxysilane, methacryloxymethyltriethoxysilane, methacryloxymethyltrimethoxysilane, methacryloxypropyltriethoxysilane, methacryloxypropyltrimethoxysilane, triethoxysilylbutyraldehyde, triethoxysilylundecanal, 4-aminobutyltriethoxysilane, 4-amino-3,3-dimethylbutyltrimethoxysilane, N-(2-aminoethyl)-3-aminopropyltriethoxysilane, p-aminophenyltrimethoxysilane, 3-aminopropyltriethoxysilane, N-(3-trimethoxysilylpropyl)pyrrole, N-(2-aminoethyl)-3-aminopropyltrimethoxysilane, N, N-bis(2-hydroxyethyl)-3-aminopropyltriethoxysilane, acetoxymethyltriethoxysilane, acetoxymethyltrimethoxysilane, 2-(carbomethyoxy)ethyltrimethoxysilane, 3-bromopropyltrimethoxysilane, (p-chloromethyl)phenyltrimethoxysilane, 3-chloropropyltriethoxysilane, (2-diethylphosphateoethyl)triethoxysilane, 3-mercaptopropyltriethoxysilane, 2-(3-trimethoxysilylpropylthio)thiophene, (3-acryloxypropyl)methyldiethoxysilane, (3-acryloxypropyl)methyldimethoxysilane, (methacryloxymethyl)methyldiethoxysilane, (methacryloxymethyl)methyldimethoxysilane, methacryloxypropylmethyldiethoxysilane, methacryloxypropylmethyldimethoxysilane, 4-amino-3,3-dimethylbutylmethyldimethoxysilane, 3-aminopropylmethyldiethoxysilane, N-(2-aminoethyl)-3-aminoisobutylmethyldimethoxysilane, N-(2-aminoethyl)-3-aminopropylmethyldiethoxysilane, chloromethylmethyldiethoxysilane, 3-chloropropylmethyldimethoxysilane, (mercaptomethyl)methyldiethoxysilane, 3-mercaptopropylmethyldimethoxysilane, (3-acryloxypropyl)dimethylmethoxysilane, (methacryloxymethyl)dimethylethoxysilane, methacryloxypropyldimethylmethoxysilane, 3-aminopropylmethyldiethoxysilane, 3-aminopropyldimethylethoxysilane, N-(2-aminoethyl)-3-aminoisobutyldimethylmethoxysilane, 3-chloroisobutyldimethylmethoxysilane, or a combination thereof.

Embodiment 23 is the method of any one of embodiments 1 to 22 further comprising contacting the dried surface with a grafting molecule.

Embodiment 24 is the method of embodiment 23, wherein the grafting molecule comprises a zwitterionic compound.

Embodiment 25 is the method of embodiment 24, wherein the zwitterionic compound comprises phosphorylcholine.

Embodiment 26 is the method of any one of embodiments 23 to 25, wherein the grafting molecule comprises phosphorylcholines include 2-methacryloyloxyethyl phosphorylcholine, 2-acryloyloxyethyl phosphorylcholine, and phosphorylcholines based on monomers such as 2-(meth)acryloyloxyethyl-2′-(trimethylammonio)ethyl phosphate, 3-(meth)acryloyloxypropyl-2′-(trimethylammonio)ethyl phosphate, 4-(meth)acryloyloxybutyl-2′-(trimethylammonio)ethyl phosphate, 5-(meth)acryloyloxypentyl-2′-(trimethylammonio)ethyl phosphate, 6-(meth)acryloyloxyhexyl-2′-(trimethylammonio)ethyl phosphate, 2-(meth)acryloyloxyethyl-2′-(triethylammonio)ethyl phosphate, 2-(meth)acryloyloxyethyl-2′-(tripropylammonio)ethyl phosphate, 2-(meth)acryloyloxyethyl-2′-(tributylammonio)ethyl phosphate, 2-(meth)acryloyloxypropyl-2′-(trimethylammonio)ethyl phosphate, 2-(meth)acryloyloxybutyl-2′-(trimethylammonio)ethyl phosphate, 2-(meth)acryloyloxypentyl-2′-(trimethylammonio)ethyl phosphate, 2-(meth)acryloyloxyhexyl-2′-(trimethylammonio)ethyl phosphate, 2-(meth)acryloyloxyethyl-3′-(trimethylammonio)propyl phosphate, 3-(meth)acryloyloxypropyl-3′-(trimethylammonio)propyl phosphate, 4-(meth)acryloyloxybutyl-3′-(trimethylammonio)propyl phosphate, 5-(meth)acryloyloxypentyl-3′-(trimethylammonio)propyl phosphate, 6-(meth)acryloyloxyhexyl-3′-(trimethylammonio)propyl phosphate, 2-(meth)acryloyloxyethyl-4-(trimethylammonio)butyl phosphate, 3-(meth)acryloyloxypropyl-4′-(trimethylammonio)butyl phosphate, 4-(meth)acryloyloxybutyl-4′-(trimethylammonio)butyl phosphate, 5-(meth)acryloyloxypentyl-4′-(trimethylammonio)butyl phosphate, 6-(meth)acryloyloxyhexyl-4′-(trimethylammonio)butyl phosphate, or a combinations thereof.

Embodiment 27 is a substrate comprising:
a surface; and
a silane coating grafted onto the surface, the silane coating comprising silanes prepared from one or more monoalkoxysilanes, dialkoxysilanes, or a combination thereof,
wherein the coating exhibits a silicon elemental concentration of 0.5 atomic % or more.

Embodiment 28 is the substrate of embodiment 27, wherein the substrate comprises a metal, optionally wherein the metal comprises nitinol, titanium, cobalt chromium, or steel.

Embodiment 29 is the substrate of embodiment 27, wherein the silanes are represented by Formula (I):

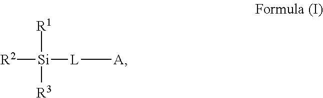

wherein L is a linker, A is a functional group, R¹, R², and R³ are independently alkoxyl or alkyl groups, wherein one or two of R¹, R², and R³ is an alkoxyl group and one or two of R¹, R², and R³ comprise an alkyl comprising 1 to 6 carbon atoms, optionally wherein the alkyl is straight, branched, or cyclic, optionally wherein the alkyl is substituted with one or more hetero atoms comprising N or S.

Embodiment 30 is the substrate of embodiment 27, wherein the alkyl groups independently comprise methyl, ethyl, or propyl.

Embodiment 31 is the substrate of embodiment 27, wherein the siloxane coating is free or substantially free of trialkoxysilanes.

Embodiment 32 is the substrate of any one of embodiments 27 to 31, wherein the alkoxysilanes comprise (3-glycidyloxypropyl) methoxydimethylsilane, (3-mercaptopropyl)methyldimethoxysilane, dimethylmethoxy(4-chlorophenyl)silane, 3-chloropropylmethyldimethoxysilane, 3-acetoxypropylmethyldimethoxysilane, 2,2-dimethoxy-1-thia-2-silacyclopentane, (methacryloxymethyl)methyldimethoxysilane, methoxydiethylenoxypropyldimethylchlorosilane, n-dodecyltrimethoxysilane, 3-glycidoxypropyltrimethoxysilane, 2-(3,4-epoxycyclohexyl)ethyl-triethoxysilane, 2-(3,4-epoxycyclohexyl)ethyl-trimethoxysilane, (3-glycidoxypropyl)trimethoxysilane, (3-glycidoxypropyl)triethoxysilane, 5,6-epoxyhexyltri-ethoxysilane, 3-isocyanatopropyltriethoxysilane, (isocyanatomethyl)methyldimethoxysilane, 3-isocyanatopropyltrimethoxysilane, tris(3-trimethoxysilylpropylisocyanurate, (3-triethoxysilylpropyl)-t-butylcarbamate, triethoxysilylpropylethylcarbamate, 3-thiocyanatopropyltriethoxysilane, 3-acrylamidopropyltrimethoxysilane, N-(3-acryloxy-2-hydroxypropyl)-3-aminopropyltriethoxysilane, acryloxymethyltrimethoxysilane, (acryloxymethyl)phenethyltrimethoxysilane, (3-acryloxypropyl)trimethoxysilane, O-(3-methacryloxy-2-hydroxypropyl)-3-aminopropyltriethoxysilane, methacryloxymethyltriethoxysilane, methacryloxymethyltrimethoxysilane, methacryloxypropyltriethoxysilane, methacryloxypropyltrimethoxysilane, triethoxysilylbutyraldehyde, triethoxysilylundecanal, 4-aminobutyltriethoxysilane, 4-amino-3,3-dimethylbutyltrimethoxysilane, N-(2-aminoethyl)-3-aminopropyltriethoxysilane, p-aminophenyltrimethoxysilane, 3-aminopropyltriethoxysilane, N-(3-trimethoxysilylpropyl)pyrrole, N-(2-aminoethyl)-3-aminopropyltrimethoxysilane, N, N-bis(2-hydroxyethyl)-3-aminopropyltriethoxysilane, acetoxymethyltriethoxysilane, acetoxymethyltrimethoxysilane, 2-(carbomethyoxy)ethyltrimethoxysilane, 3-bromopropyltrimethoxysilane, (p-chloromethyl)phenyltrimethoxysilane, 3-chloropropyltriethoxysilane, (2-diethylphosphateoethyl)triethoxysilane, 3-mercaptopropyltriethoxysilane, 2-(3-trimethoxysilylpropylthio)thiophene, (3-acryloxypropyl)methyldiethoxysilane, (3-acryloxypropyl)methyldimethoxysilane, (methacryloxymethyl)methyldiethoxysilane, (methacryloxymethyl)methyldimethoxysilane, methacryloxypropylmethyldiethoxysilane, methacryloxypropylmethyldimethoxysilane, 4-amino-3,3-dimethylbutylmethyldimethoxysilane, 3-aminopropylmethyldiethoxysilane, N-(2-aminoethyl)-3-aminoisobutylmethyldimethoxysilane, N-(2-aminoethyl)-3-aminopropylmethyldiethoxysilane, chloromethylmethyldiethoxysilane, 3-chloropropylmethyldimethoxysilane, (mercaptomethyl)methyldiethoxysilane, 3-mercaptopropylmethyldimethoxysilane, (3-acryloxypropyl)dimethylmethoxysilane, (methacryloxymethyl)dimethylethoxysilane, methacryloxypropyldimethylmethoxysilane, 3-aminopropylmethyldiethoxysilane, 3-aminopropyldimethylethoxysilane, N-(2-aminoethyl)-3-aminoisobutyldimethylmethoxysilane, 3-chloroisobutyldimethylmethoxysilane, or a combination thereof.

Embodiment 33 is the substrate of any one of embodiments 27 to 32, further comprising a grafting molecule covalently coupled with the silane.

Embodiment 34 is the substrate of embodiment 33, wherein the grafting molecule comprises a zwitterionic compound.

Embodiment 35 is the substrate of embodiment 34, wherein the zwitterionic compound comprises phosphorylcholine.

Embodiment 36 is the substrate of any one of embodiments 27 to 35, wherein the grafting molecule comprises phosphorylcholines include 2-methacryloyloxyethyl phosphorylcholine, 2-acryloyloxyethyl phosphorylcholine, and phosphorylcholines based on monomers such as 2-(meth)acryloyloxyethyl-2′-(trimethylammonio)ethyl phosphate, 3-(meth)acryloyloxypropyl-2′-(trimethylammonio)ethyl phosphate, 4-(meth)acryloyloxybutyl-2′-(trimethylammonio)ethyl phosphate, 5-(meth)acryloyloxypentyl-2′-(trimethylammonio)ethyl phosphate, 6-(meth)acryloyloxyhexyl-2′-(trimethylammonio)ethyl phosphate, 2-(meth)acryloyloxyethyl-2′-(triethylammonio)ethyl phosphate, 2-(meth)acryloyloxyethyl-2′-(tripropylammonio)ethyl phosphate, 2-(meth)acryloyloxyethyl-2′-(tributylammonio)ethyl phosphate, 2-(meth)acryloyloxypropyl-2′-(trimethylammonio)ethyl phosphate, 2-(meth)acryloyloxybutyl-2′-(trimethylammonio)ethyl phosphate, 2-(meth)acryloyloxypentyl-2′-(trimethylammonio)ethyl phosphate, 2-(meth)acryloyloxyhexyl-2′-(trimethylammonio)ethyl phosphate, 2-(meth)acryloyloxyethyl-3′-(trimethylammonio)propyl phosphate, 3-(meth)acryloyloxypropyl-3′-(trimethylammonio)propyl phosphate, 4-(meth)acryloyloxybutyl-3′-(trimethylammonio)propyl phosphate, 5-(meth)acryloyloxypentyl-3′-(trimethylammonio)propyl phosphate, 6-(meth)acryloyloxyhexyl-3′-(trimethylammonio)propyl phosphate, 2-(meth)acryloyloxyethyl-4-(trimethylammonio)butyl phosphate, 3-(meth)acryloyloxypropyl-4′-(trimethylammonio)butyl phosphate, 4-(meth)acryloyloxybutyl-4′-(trimethylammonio)butyl phosphate, 5-(meth)acryloyloxypentyl-4′-(trimethylammonio)butyl phosphate, 6-(meth)acryloyloxyhexyl-4′-(trimethylammonio)butyl phosphate, or a combinations thereof.

### EXAMPLES

TABLE 1
Reagents used in the Examples

| Reagent | Source |
|---|---|
| Sodium hydroxide (NaOH) | Fisher Scientific |
| Deionized (DI) water | house made |
| Nitinol coupons | Fort Wayne Metals in Fort Wayne, IN |
| (3-glycidyloxypropyl) | Gelest, Inc. in Morrisville, PA |
| trimethoxysilane (GPTS) | |
| (3-glycidyloxypropyl) | Gelest, Inc. |
| dimethoxymethylsilane (GPDS) | |
| (3-glycidyloxypropyl) | Gelest, Inc. |
| methoxydimethylsilane (GPMS) | |
| 100% ethanol | Sigma Aldrich, Fisher Scientific |
| LIPIDURE-NH1 | NOF Corporation in Tokyo, Japan |

### Example 1

The grafting efficiency of the method of the present disclosure was tested for trialkoxysilane, dialkoxysilane, and monoalkoxysilane. The trialkoxysilane (GPTS), dialkoxysilane (GPDS), and monoalkoxysilane (GPMS) were grafted onto a nitinol surface. Two methods of preparing the reagent solution were tested to compare the grafting efficiency of trialkoxysilane by the method of present disclosure to a prior art method that did not include pH treatment of the reagent solution. In the first method, the pH of the reagent solution was first lowered by addition of hydrochloric acid, then increased immediately before treatment of the nitinol coupon. The first method is consistent with the methods described herein. In the second, comparative method, the reagent solution pH was not altered.

| | | Silane type | | |
|---|---|---|---|---|
| | | GPTS | GPDS | GPMS |
| Treatment | pH treated | Sample 1 | Sample 2 | Sample 3 |
| | not pH treated | Sample C1 | | |
| | (comparative) | | | |

pH treated Reagent Solutions

Reagent solutions were prepared by combining 95 mL of 100% ethanol, 4.8 mL of 0.01 M hydrochloric acid (HCl). 2 mL of alkoxysilane was added to each reagent solution using a syringe to minimize air contact. The reagent solutions were mixed on an orbital shaker at for 80 minutes. After 80 minutes, the reagent solutions were neutralized by addition of 4.8 mL of 0.01 M sodium hydroxide (NaOH). The reagent solution was mixed for one minute. The pH of the solution was 5.

### Comparative Reagent Solutions

Comparative reagent solutions were prepared similar to the pH treated reagent solutions but without the HCl and neuralization by NaOH. The comparative reagent solutions were mixed on the orbital shaker for 80 minutes before use.

### Substrate Preparation

Nitinol coupons were activated by immersing the coupons in 20% aqueous NaOH solution for 90 minutes and rinsing in 50% ethanol for 2 minutes.

### Silanization

Immediately after preparation, the nitinol coupons were immersed in the prepared reagent solutions. Each prepared reagent solution with the nitinol coupon was mixed on an orbital shaker for 5 minutes. The nitinol coupons were withdrawn slowly from the reagent solution. The nitinol coupons were then cured in an oven at 110° C. for 1 hour. After curing, the nitinol coupons were cooled to room temperature. The coupons were placed in ethanol and sonicated for 3 minutes, then transferred into DI water and sonicated for 3 minutes. The coupons were dried with compressed nitrogen.

### Elemental Analysis

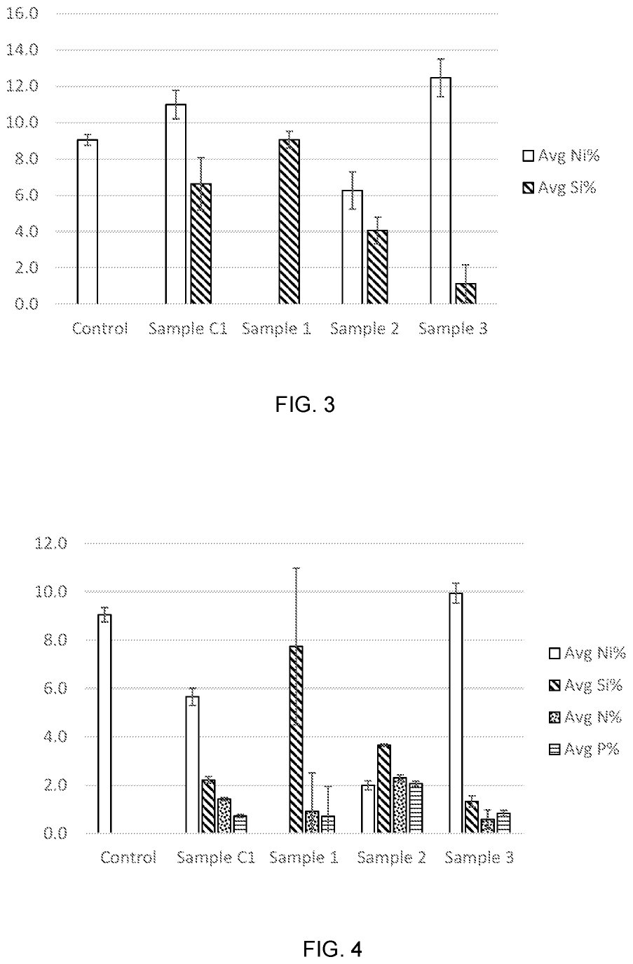

The efficiency of the grafting method was evaluated by measuring elemental composition at the surface of the nitinol coupons by XPS. Nickel content was unique to the nitinol substrate and therefore correlated inversely with silane density at the surface. Conversely, silicon content was unique to the silane molecules and therefore correlated directly with quantity of silane at the surface. An uncoated nitinol coupon was used as a control. The results are shown in FIG. 3.

Comparing Sample 1 to Sample Cl, it was observed that the method of the present disclosure resulted in a silane coating with no nitinol exposed. It was concluded that the method of the present disclosure could be used to prepare a thicker silane coating with better coverage than the control method. It was further observed from Samples 2 and 3 that the method of the present disclosure could be used to effectively graft di- and monoalkoxysilanes onto nitinol whereas the control method would not do so.

### Example 2

In this Example, a zwitterionic polymer (LIPIDURE) was conjugated to each of the nitinol coupons grafted with GPTS, GPDS, and GPMS from Example 1.

The nitinol coupons were immersed in a solution of LIPIDURE and were cured at 80° C. for 30 minutes, then cooled to room temperature.

### Elemental Analysis

Grafting efficiency was evaluated by measuring elemental composition at the surface of the nitinol coupons by XPS. Nickel content was unique to the nitinol substrate and therefore correlated inversely with amount of silane and LIPIDURE. Silicon content was unique to the silane molecules and therefore correlated to quantity of silane at the surface. Nitrogen and phosphorus were unique to LIPIDURE and therefore correlated with quantity of LIPIDURE at the surface. An uncoated nitinol coupon was used as a control. The results are shown in FIG. 4.

All references and publications cited herein are expressly incorporated herein by reference in their entirety into this disclosure, except to the extent they may directly contradict this disclosure. Although specific embodiments have been illustrated and described herein, it will be appreciated by those of ordinary skill in the art that a variety of alternate and/or equivalent implementations can be substituted for the specific embodiments shown and described without departing from the scope of the present disclosure. It should be understood that this disclosure is not intended to be unduly limited by the illustrative embodiments and examples set forth herein and that such examples and embodiments are presented by way of example only with the scope of the disclosure intended to be limited only by the claims set forth here.

Example 1. A method of silanizing a surface of a substrate, the method comprising: preparing a reagent solution comprising one or more alkoxysilanes by lowering a pH of the reagent solution to pH 1 to 6.5; increasing the pH of the reagent solution to pH 4 to 8; activating the surface to introduce reactive groups; contacting the activated surface with the reagent solution; and drying the surface.

Example 2. The method of Example 1, wherein the alkoxysilanes comprise monoalkoxysilanes, dialkoxysilanes, or a combination thereof.

Example 3. A method of silanizing a surface of a substrate, the method comprising: ctivating the surface to introduce reactive groups; contacting the activated surface with a reagent solution comprising monoalkoxysilanes, dialkoxysilanes, or a combination thereof; and drying the surface.

Example 4. The method of any one of Examples 1 to 3, wherein the reactive groups are hydroxyl groups.

Example 5. The method of any one of Examples 1 to 4, wherein the surface is activated using an activation solution comprising water and a base.

Example 6. The method of any one of Examples 1 to 5, wherein the surface is activated using oxygen plasma.

Example 7. The method of any one of Examples 1 to 6, wherein the substrate comprises a metal, optionally wherein the metal comprises nitinol, titanium, cobalt chromium, or steel.

Example 8. The method of any one of Examples 1 to 7, wherein the reagent solution comprises an alcohol and water.

Example 9. The method of Example 8, wherein the alcohol is selected from ethanol, methanol, isopropanol, and combinations thereof.

Example 10. The method of any one of Examples 1 to 9, wherein the reagent solution comprises from 0.5 vol-% to 50 vol-% water, from 1 vol-% to 10 vol-%, or from 2 vol-% to 8 vol-% water, optionally with the balance ethanol.

Example 11. The method of any one of Examples 1 to 10, wherein the reagent solution has a pH from 4.5 to 8, 6 to 8, or about 7 when contacting with the surface.

Example 12. The method of any one of Examples 1 to 11, wherein the method results in a silicon content of 0.5 atomic % or greater on the surface.

Example 13. The method of any one of Examples 1 to 12, wherein drying occurs in a vacuum.

Example 14. The method of any one of Examples 1 to 13, wherein drying occurs at a temperature between 90° C. to 200° C.

Example 15. The method of any one of Examples 1 to 14, wherein the reagent solution comprises monoalkoxysilanes represented by Formula (I):

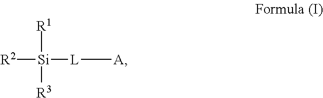

wherein L is a linker, A is a functional group, R¹, R², and R³ are independently alkoxyl or alkyl groups, at least one of R¹, R², and R³ being an alkoxyl group.

Example 16. The method of Example 15, wherein the reagent solution comprises monoalkoxysilanes, and wherein R1 is methoxyl, ethoxyl, or propoxyl.

Example 17. The method of Example 15 or 16, wherein functional group A comprises an epoxide, a carboxylic acid, a halide, a (meth)acrylate, an alkoxyl, a cyanato, a thiol, or an amine.

Example 18. The method of any one of Examples 1 to 17, wherein linker L comprises a carbon-containing group with up to 20 carbon atoms, up to 10 carbon atoms, 1 to 5 carbon atoms, 1 to 4 carbon atoms, 1 to 3 carbon atoms, or 1 or 2 carbon atoms, optionally comprising one or more heteroatoms selected from oxygen, nitrogen, and sulfur, wherein linker L is saturated or unsaturated, and wherein linker L is linear, branched, and optionally includes one or more cyclic groups.

Example 19. The method of Example 18, wherein linker L comprises an alkyl, alkoxyl, one or more polyethylene glycol repeats, phenyl, or a combination thereof.

Example 20. The method of any one of Examples 1 to 19, wherein the reagent solution is free or substantially free of trialkoxysilanes.

Example 21. The method of any one of Examples 1 to 20 further comprising contacting the dried surface with a grafting molecule.

Example 22. The method of Example 21, wherein the grafting molecule comprises a zwitterionic compound.

Example 23. The method of Example 22, wherein the zwitterionic compound comprises phosphorylcholine.

Example 24. A substrate comprising: a surface; and a silane coating grafted onto the surface, the silane coating comprising silanes prepared from one or more monoalkoxysilanes, dialkoxysilanes, or a combination thereof, wherein the coating exhibits a silicon elemental concentration of 0.5 atomic % or more.

Example 25. The substrate of Example 24, wherein the substrate comprises a metal, optionally wherein the metal comprises nitinol, titanium, cobalt chromium, or steel.

Example 26. The substrate of Example 24, wherein the silanes are represented by Formula (I):

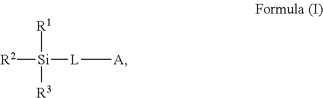

wherein L is a linker, A is a functional group, R¹, R², and R³ are independently alkoxyl or alkyl groups, wherein one or two of R¹, R², and R³ is an alkoxyl group and one or two of R¹, R², and R³ comprise an alkyl comprising 1 to 6 carbon atoms, optionally wherein the alkyl is straight, branched, or cyclic, optionally wherein the alkyl is substituted with one or more hetero atoms comprising N or S.

Example 27. The substrate of Example 26, wherein the alkyl groups independently comprise methyl, ethyl, or propyl.

Example 28. The substrate of Example 20, wherein the silane coating is free or substantially free of trialkoxysilanes.

Example 29. The substrate of Example 20 further comprising a grafting molecule covalently coupled with the silane.

1. A method of silanizing a surface of a substrate, the method comprising:
preparing a reagent solution comprising one or more alkoxysilanes by lowering a pH of the reagent solution to pH 1 to 6.5;
increasing the pH of the reagent solution to pH 4 to 8;
activating the surface to introduce reactive groups;
contacting the activated surface with the reagent solution; and
drying the surface.

2. The method of claim 1, wherein the alkoxysilanes comprise monoalkoxysilanes, dialkoxysilanes, or a combination thereof.

3. A method of silanizing a surface of a substrate, the method comprising:
activating the surface to introduce reactive groups;
contacting the activated surface with a reagent solution comprising monoalkoxysilanes, dialkoxysilanes, or a combination thereof; and
drying the surface.

4. The method of claim 1, wherein the surface is activated using an activation solution comprising water and a base, or oxygen plasma, and wherein the reactive groups are hydroxyl groups.

5. The method of claim 1, wherein the reagent solution comprises an alcohol and from 0.5 vol-% to 50 vol % water.

6. (canceled)

7. (canceled)

8. The method of claim 1, wherein the method results in a silicon content of 0.5 atomic % or greater on the surface.

9. The method of claim 1, wherein the reagent solution comprises monoalkoxysilanes represented by Formula (I): 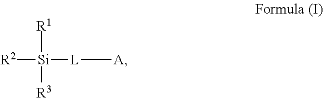
wherein L is a linker, A is a functional group, R¹, R², and R³ are independently alkoxyl or alkyl groups, at least one of R¹, R², and R³ being an alkoxyl group.

10. The method of claim 1, wherein linker L comprises a carbon-containing group with up to 20 carbon atoms.

11. The method of claim 1, wherein the reagent solution is free or substantially free of trialkoxysilanes.

12. The method of claim 1 further comprising contacting the dried surface with a grafting molecule, wherein the grafting molecule comprises a zwitterionic compound and wherein the zwitterionic compound comprises phosphorylcholine.

13. A substrate comprising:
a surface; and
a silane coating grafted onto the surface, the silane coating comprising silanes prepared from one or more monoalkoxysilanes, dialkoxysilanes, or a combination thereof,
wherein the coating exhibits a silicon elemental concentration of 0.5 atomic % or more;

14. The method or substrate of claim 13, wherein the substrate comprises a metal.

15. The substrate of claim 13, wherein the silanes are represented by Formula (I): 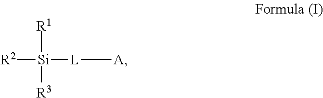
wherein L is a linker, A is a functional group, R¹, R², and R³ are independently alkoxyl or alkyl groups, wherein one or two of R¹, R², and R³ is an alkoxyl group and one or two of R¹, R², and R³ comprise an alkyl comprising 1 to 6 carbon atoms.

16. The method of claim 3, wherein the surface is activated using an activation solution comprising water and a base, or oxygen plasma, and wherein the reactive groups are hydroxyl groups.

17. The method of claim 3, wherein the reagent solution comprises an alcohol and from 0.5 vol % to 50 vol-% water.

18. The method of claim 3, wherein the reagent solution has a pH from 4.5 to 8 when contacting with the surface.

19. The method of claim 3, wherein the method results in a silicon content of 0.5 atomic % or greater on the surface.

20. The method of claim 3, wherein the reagent solution comprises monoalkoxysilanes represented by Formula (I): 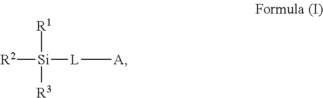
wherein L is a linker, A is a functional group, R¹, R², and R³ are independently alkoxyl or alkyl groups, at least one of R¹, R², and R³ being an alkoxyl group.

21. The method of claim 3, wherein the reagent solution is free or substantially free of trialkoxysilanes.

22. The method of claim 3, further comprising contacting the dried surface with a grafting molecule, wherein the grafting molecule comprises a zwitterionic compound and wherein the zwitterionic compound comprises phosphorylcholine.
